(19) United States
(12) Patent Application Publication
(10) Pub. No.: US 2008/0231714 A1
(43) Pub. Date: Sep. 25, 2008

(54) System and method for capturing images

(75) Inventors: Leonardo William Estevez, Rowlett, TX (US); Aziz U. Batur, Dallas, TX (US); Sang-Yong Lee, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/726,610

(22) Filed: Mar. 22, 2007

(51) Int. Cl. H04N 5/225; H04N 5/228; G03B 17/00; H04N 5/238

(52) U.S. Cl. 348/208.16; 348/208.7; 396/55; 348/367

(57) ABSTRACT

System and method for capturing images with reduced blur. An embodiment includes an image sensor to capture optical information, a shutter coupled to the image sensor, a motion sensor to measure movement of an electronic device, and a processor coupled to the image sensor, to the shutter, and to the motion sensor. The shutter initiates a capturing of optical information, and the processor controls a state of the shutter based on predicted future movements of the electronic device based on movement information from the motion sensor. The predicted future movements permit a determination of image capture time to reduce blur.

### TECHNICAL FIELD

The present invention relates generally to a system and method for capturing images, and more particularly to a system and method for capturing images with reduced blur.

### BACKGROUND

Camera movement while a picture is being taken may result in an image that has undesired blurring. The movement may be due to the person holding the camera or the operating environment in which the camera is being used. For example, the person taking the picture may be physically incapable of holding the camera steady, the person may be sitting in a moving vehicle, the person may be standing on a vibrating platform, or so forth. The movement of the camera may be intensified by the image's exposure conditions, for example, a long exposure can increase the probability of the camera movements being captured in the image.

There are several techniques in wide use today for helping to reduce or eliminate blur in images. A first technique involves the use of optical image stabilization and may be achieved by moving either the camera's lens system or image sensor to reduce the effects of any camera movement on an image being captured. The camera's lens system and/or image sensor may be moved so that a portion of the image being cast onto the image sensor remains relatively motion free. Alternatively, in digital image stabilization, the image on the image sensor may be moved so that a portion of the image remains relatively motion free on the image sensor.

In yet another alternative, digital signal processing of image data captured by an image sensor may be used to detect lack of focus or the presence of motion in the image. For example, filtering the image data with a high-pass filter may provide information about the motion present in the image. If the filtered image data indicates that too much blurriness is present, then the user may be notified or the image capture may be rejected. Furthermore, the camera may be stabilized using gyros, for example, to help prevent vibrations in the environment or from the user from moving the camera.

### SUMMARY OF THE INVENTION

These and other problems are generally solved or circumvented, and technical advantages are generally achieved, by embodiments of a system and a method for capturing images with reduced blur.

In accordance with an embodiment, an electronic device is provided. The electronic device includes an image sensor to capture optical information, a shutter coupled to the image sensor to initiate a capturing of optical information by the image sensor, a motion sensor to measure movement of the electronic device, and a processor coupled to the image sensor, to the shutter, and to the motion sensor. The processor controls a state of the shutter based on predicted future movements of the electronic device, wherein the predicted future movements are based on movement information provided by the motion sensor.

In accordance with another embodiment, a method for capturing a still image is provided. The method includes determining exposure conditions, retrieving motion information, notifying a user if the motion information exceeds a minimum motion, and capturing the still image if the motion information does not exceed the minimum motion.

In accordance with another embodiment, a method for capturing a still image is provided. The method includes determining exposure conditions, retrieving motion information, capturing the still image in response to a determining that the motion information does not exceed a minimum threshold motion, and in response to the determination that the motion information exceeds the minimum threshold motion, selecting an image capture time based on the motion information, waiting until the image capture time, and capturing the still image.

An advantage of an embodiment is that it requires a modest increase in hardware and software to help improve the quality of images taken by an image capture device. This may have a minimal impact on the cost of the camera. Complex image stabilization or image capture device stabilization is not required. Thus, complex hardware and/or software techniques for image and/or image capture device stabilization are not needed, which may help to maintain a cost advantage over image capture devices needing the complex stabilization hardware and/or software.

Another advantage of an embodiment is that the reduction of image blur occurs prior to any image data being captured or sensed by an image sensor, thereby potentially reducing power consumption by keeping the image sensor powered down until an image is ready to be captured. Reduced power consumption may permit the use of a smaller power source to help reduce the size of the image capture device or to increase the number of images that may be captured before having to replace or recharge the power source.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIGS. 1a and 1b are diagrams of a high-level view and a detailed functional view of an image capture device;

FIG. 2 is a diagram of an algorithm for an image capture device to make use of motion information to help a user capture images;

FIG. 3 is a diagram of a data arrangement for storing image data with motion information;

FIGS. 4a and 4b are diagrams of exemplary motion information provided by a motion sensor;

FIG. 5 is a diagram of a time domain plot of motion information from a motion sensor;

FIG. 6 is a diagram of a plot of historical and predicted motion information; and

FIG. 7 is a diagram of an algorithm for an image capture device to make use of motion information to help a user capture images.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a digital optical camera with a motion sensor. The invention may also be applied, however, to other types of cameras, such as film cameras. Additionally, the invention may be applied to video cameras with still picture capability, as well as portable electronic devices with image capture capability.

Vibrations, quivers, non-linear motions, and so forth, of an image capture device may typically be periodic in nature. For example, if a user is holding an image capture device, then each beat of the heart may cause a vibration. Vibrations induced by a heart beat may have a frequency about equal to the user's heart rate. If a user is riding in a vehicle with an unbalanced tire, the vibrations induced by the unbalanced tire may also be periodic. The periodicity of these vibrations and others may be characterized and used to help an image capture device and a user capture images with less blur.

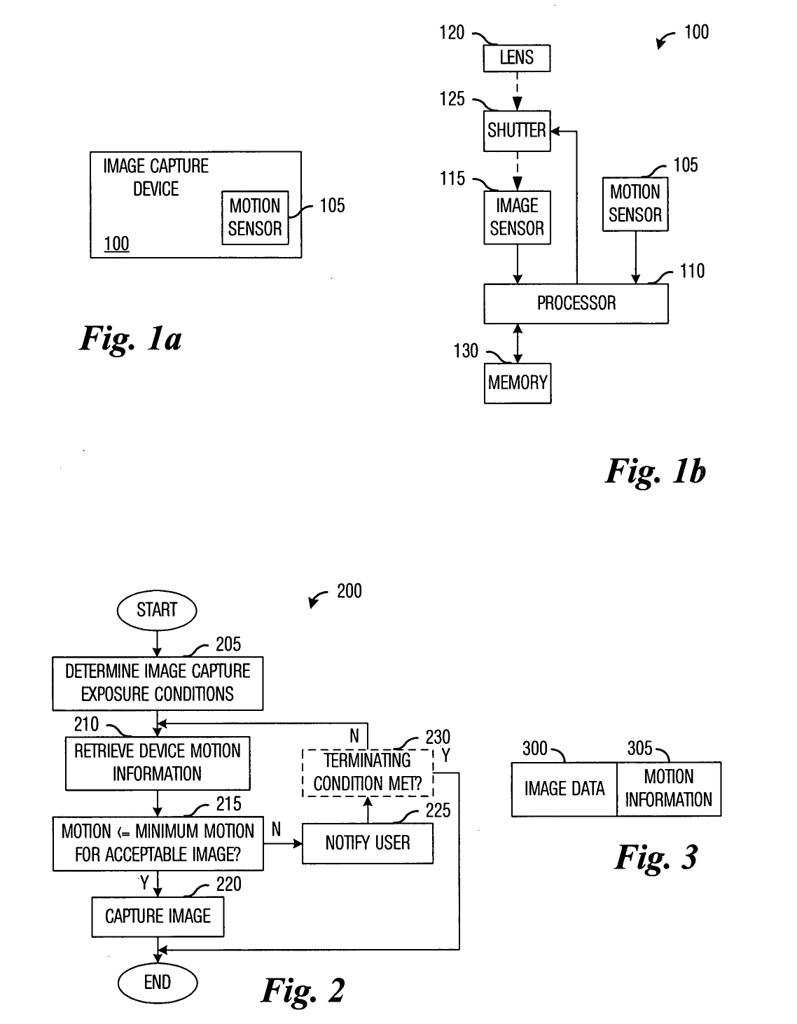

With reference now to FIGS. 1a and 1b, there are shown diagrams illustrating a high-level view of an image capture device 100 and a detailed functional view of the image capture device 100. The image capture device 100 may be a still image camera (digital or film), a video camera with still image capture capability, a telephone with still image capture capability, or any other electronic device with still image capture capability. In addition to hardware necessary to capture still images, the image capture device 100 may include a motion sensor 105. The motion sensor 105 may be used to detect movement, such as vibrations, quivers, non-linear motion, and so forth, of the image capture device 100. Examples of motion sensors may include gyroscopic devices, such as accelerometers, angular accelerometers, and so on, non-invasive detecting sensors, such as ultrasonic sensors, and so forth, inductive position sensors, and so on. The motion sensors may detect motion or changes in position in the image capture device 100.

The image capture device 100 may also include a processor 110 coupled to the motion sensor 105, as shown in FIG. 1b. The processor 110 may take the motion information provided by the motion sensor 105 and process it to help the image capture device 100 take better quality still images. An image sensor 115 may be used to convert light information into electronic information (for example, an optoelectric converter, such as a charge coupled device sensor in a digital image capture device) or chemical information (for example, a light sensitive emulsion on a photographic film in a film-based image capture device). A lens system 120 may be used to focus and/or zoom light reflecting from an image, and a shutter 125 may modulate light from the lens system 120 onto the image sensor 115. The shutter 125 may be a mechanical device that may block light when closed and pass light when open. The light passed by the shutter 125 may then be incident on the image sensor 115.

If the image capture device 100 is digital in nature, then a memory 130 may be used to store the electronic image information from the image sensor 115. If the image capture device 100 is a film image capture device, then the memory 130 may not be necessary for image information storage, however, the memory 130 may still be available and may be used to store configuration information, image exposure information, and so on. Additionally, some digital image capture devices may not have a mechanical shutter, rather, they may have an electronic shutter which may initiate the transfer of electronic information from the image sensor 115 to the memory 130. In such a configuration, the light from the lens system 120 is always incident on the image sensor 115, but the image data may only be recorded when the electronic shutter initiates the transfer of the electronic information to the memory 130.

Based on the motion information provided by the motion sensor 105, the processor 110 may control the shutter 125. Depending on preprogrammed information or user input information, the processor 110 may block the actuation of the shutter 125, either mechanically or electronically, if the motion information provided by the motion sensor 105 exceeds a specified amount. For example, if the motion sensor 105 detects that the magnitude of the vibrations of the image capture device 100 exceeds a specified amount, then the processor 110 may prevent the actuation of the shutter 125. However, if the magnitude of the vibrations is less than the specified amount, then the processor 110 may permit the actuation of the shutter 125 to take place.

With reference now to FIG. 2, there is shown a diagram illustrating an algorithm 200 for an image capture device to make use of motion information to help a user capture images. The algorithm 200 may execute in a controller or a microprocessor used to control the operation of an image capture device, such as the processor 110 of the image capture device 100. The algorithm 200 may begin executing when a user of the image capture device 100 depresses a shutter button to capture an image. With the shutter button depressed, the image capture device 100 measures exposure settings needed to capture an image based on lighting conditions (block 205). The exposure settings may include shutter speed (exposure time), use of flash, lens focal length, lens aperture size, and so forth. The exposure may have a significant impact on the amount of blur present in the captured image. For example, if the shutter speed is very short (less than 1/128^{th} of a second in duration) then blur is unlikely to be present in the captured image.

After measuring the exposure settings, the image capture device 100 may retrieve image capture device motion information from the motion sensor 105 (block 210). The image capture device 100 may then determine if there is too much motion to capture an image without an excessive amount of blur. This may be accomplished by comparing the motion information from the motion sensor 105 with a minimum amount of motion allowable for an acceptable image (block 215). The minimum amount of motion may be a threshold value and may vary depending on the exposure settings. For example, if the shutter speed is long, then the minimum amount of motion may be low, while if the shutter speed is very short, then the minimum amount of motion may be high.

If there is not too much motion to capture an image without excessive blur, then the image capture device 100 may permit the image capture to proceed (block 220). This may include allowing the shutter 125 to open to expose the image sensor 115 to the light from the lens system 120 or to initiate a transfer of electronic information from the image sensor 115 in a situation when the image sensor 115 is always exposed to light. If there is too much motion to capture an image without excessive blur, then the image capture device 100 may notify the user of the excessive motion (block 225). The image capture device 100 may notify the user of the excessive motion by blinking a light, displaying a “shake” indicator on a display of the image capture device 100, play a warning sound, vibrating the image capture device 100, or so on. After notifying the user, the image capture device 100 may return to block 210 to retrieve new image capture device motion information to repeat the determination if an image may be captured. Optionally, the image capture device 100 may repeat the determination if an image may be captured until a terminating condition is met (block 230). Examples of a terminating condition may include the user releasing the shutter button, an image has been captured, the expiration of a specified amount of time, or so forth.

With reference now to FIG. 3, there is shown a diagram illustrating a data arrangement for storing image data with motion information. The image data 300 captured by an image sensor of a digital image capture device may be stored in a memory. Additional data may be stored with the image data, including exposure settings. Furthermore, the motion information 305 may also be stored with the image data. The motion information may be used to organize the images. For example, a group of images with a similar set of motion data is likely to have been captured by a single user, while images with motion information significantly different from the remainder of the images are likely to have been captured by a user that is not the owner and the owner may be in the images, and so on.

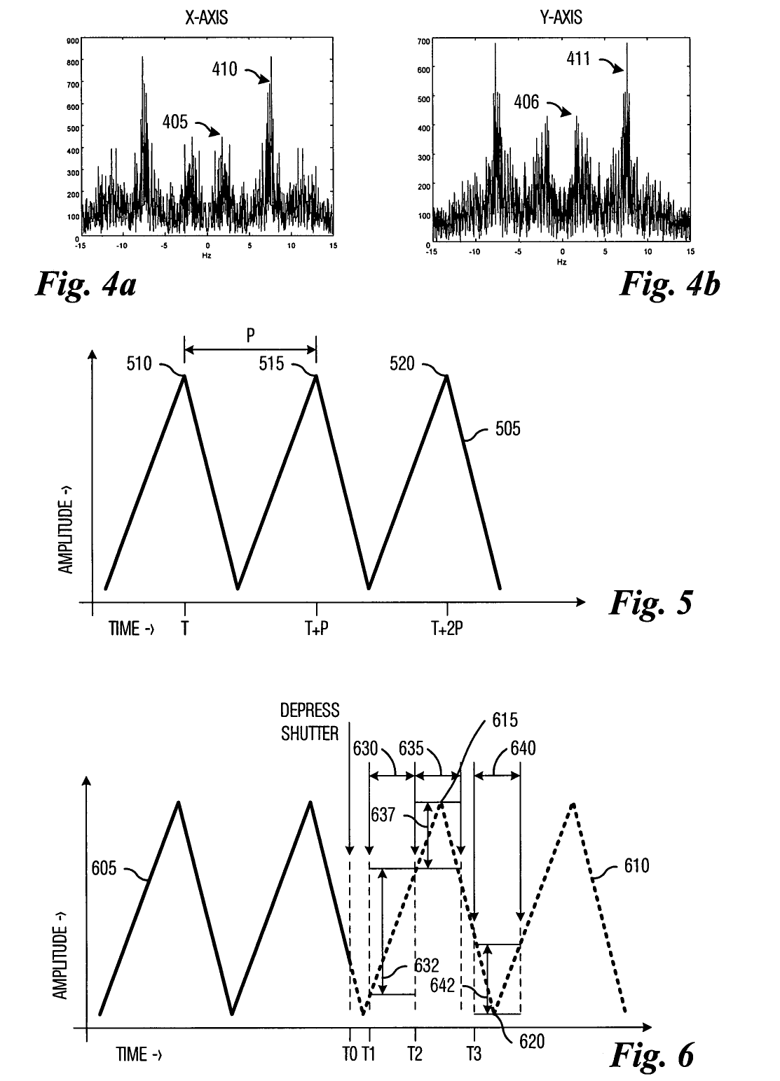

With reference now to FIGS. 4a and 4b, there are shown diagrams illustrating exemplary motion information provided by a motion sensor of an image capture device. The diagrams shown in FIGS. 4a and 4b illustrate frequency domain plots of motion information from a motion sensor, such as the motion sensor 105, with the diagram shown in FIG. 4a illustrating motion in an X-axis and the diagram shown in FIG. 4b illustrating motion in a Y-axis. Examination of the diagrams shows that there may be periodic vibrations of an image capture device, with a first periodic vibration may have a frequency of about two (2) Hz (shown in FIG. 4a as spike 405 and FIG. 4b as spike 406) and a second periodic vibration may have a frequency of about eight (8) Hz (shown in FIG. 4a as spike 410 and FIG. 4b as spike 411).

With reference now to FIG. 5, there is shown a diagram illustrating a time domain plot of motion information from a motion sensor, such as the motion sensor 105. A trace 505 illustrates the motion information as provided by the motion sensor 105. The motion information indicates that the motion may be periodic in nature with a period equal to about P. The diagram shows that a first peak 510 occurs at about time T and a second peak 515 occurs at about time T+P and a third peak 520 occurs at about time T+2P.

The periodic nature of the movements and vibrations of an image capture device may be used to predict the occurrence of subsequent movements and vibrations. It may be possible to characterize the nature of the movements and vibrations of an image capture device by processing historic motion information. The characterization of the movements and vibrations may include a determination of frequencies and periods of recurrent movements and vibrations, along with their magnitudes. Then, it may be possible to predict the future occurrence of movements and vibrations. With movements and vibrations that are small in magnitude, it may be possible to ignore their occurrence altogether.

With reference now to FIG. 6, there is shown a diagram illustrating a plot of historical image capture device motion information and predicted image capture device motion information along with possible timings of an image capture to reduce blur. The diagram shown in FIG. 6 illustrates a first trace 605, which displays historical image capture device motion information, such as measured by the motion sensor 105 of the image capture device 100. Also shown is predicted image capture device motion information (shown as a second trace 610). The predicted image capture device motion information may be determined by the processor 110 in the image capture device 100. The predicted image capture device motion information may provide information about future occurrences of movements and vibrations, such as a movement peak 615 and a movement valley 620, along with transitions between peaks and valleys.

For illustrative purposes, let a shutter button of an image capture device be depressed by a user at time T0. At times prior to time T0, the image capture device motion information is historical, i.e., the image capture device motion information comprises actual measured movement information. For times after time T0, the image capture device motion information comprises predicted information.

If the image capture is permitted to occur as soon as possible after the depressing of the shutter button, the image capture may begin at time T1 (to allow for shutter lag) and last for a duration shown as duration 630. However, if an image was captured over the duration 630, the image capture device 100 may experience a displacement due to a motion of the image capture device 100 shown as difference 632.

It may be possible to reduce a displacement of the image capture device 100 if the image capture was initiated so that it spans a movement peak or a movement valley. For example, if the image capture was initiated at time T2 (and lasts for a duration shown as duration 635), then the image capture will span the movement peak 615 and the image capture device 100 may experience a displacement due to a motion shown as difference 637. Alternatively, if the image capture was initiated at time T3 (and lasts for a duration shown as duration 640), then the image capture will span the movement valley 620 and the image capture device 100 may experience a displacement due to a motion shown as difference 642. Either displacement, the displacement 637 or the displacement 642 may result in a smaller movement of the image capture device 100 than the displacement 632. The smaller movement of the image capture device 100 may result in an image with less blur.

Although delaying the image capture may result in an image with reduced blur, delaying the image capture for an extended amount of time may result in the loss of the user's desired composition. For example, the intended subject may move out of position while the image capture is being delayed. This may be a significant issue in sports or nature photography.

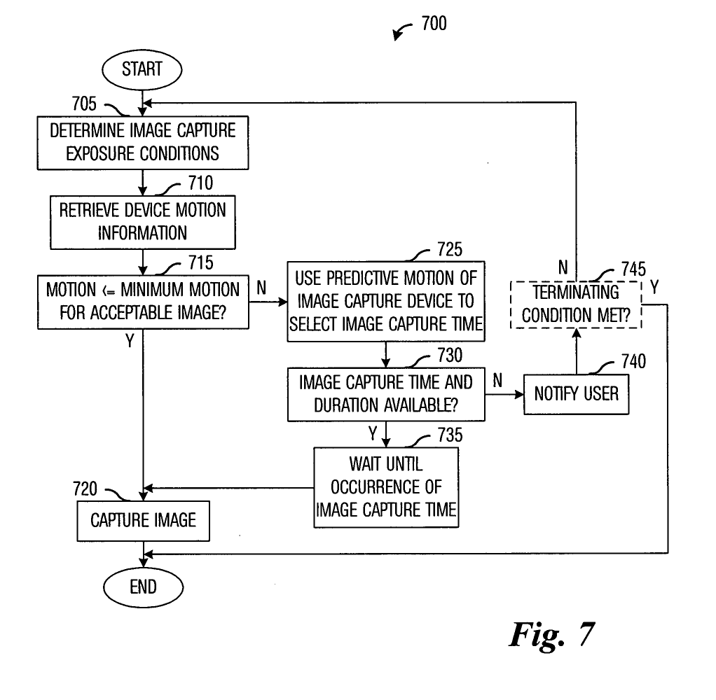

With reference now to FIG. 7, there is shown a diagram illustrating an algorithm 700 for an image capture device to make use of motion information to help a user capture images. The algorithm 700 may execute in a controller or a microprocessor used to control the operation of an image capture device, such as the processor 110 of the image capture device 100. The algorithm 700 may begin executing when a user of the image capture device 100 depresses a shutter button to capture an image. With the shutter button depressed, the image capture device 100 measures exposure settings needed to capture an image based on lighting conditions (block 705). The exposure settings may include shutter speed (exposure time), use of flash, lens focal length, and so forth. The exposure may have a significant impact on the amount of blur present in the captured image. For example, if the shutter speed is very short (less than 1/128^{th} of a second) then blur is unlikely to be present in the captured image.

After measuring the exposure settings, the image capture device 100 may retrieve image capture device motion information from the motion sensor 105 (block 710). The image capture device 100 may then determine if there is too much motion to capture an image without an excessive amount of blur. This may be accomplished by comparing the motion information from the motion sensor 105 with a minimum amount of motion allowable for an acceptable image (block 715). The minimum amount of motion may vary depending on the exposure settings. For example, if the shutter speed is long, then the minimum amount of motion may be low.

If there is not too much motion to capture an image without excessive blur, then the image capture device 100 may permit the image capture to proceed (block 720). Motion information may be stored along with the image data. The image capture may include allowing the shutter 125 to open to expose the image sensor 115 to the light from the lens system 120. If there is too much motion to capture an image without excessive blur, then the image capture device 100 may make use of predictive image capture device motion information to select an image capture time that may minimize image blur (block 725). For example, the image capture time selected may result in a spanning of a motion peak or valley during the exposure time of the image capture. Other criteria may need to be met in order for an image capture time to be selected. For example, the image capture time may not occur too far into the future since the user may not wish to wait an extended period of time before beginning the image capture, the image capture time may need to be of sufficient duration to meet the required exposure settings of the image capture, and so forth.

A check may be made to determine if an image capture time is available and if the image capture time has adequate duration to capture the image based on the exposure settings (block 730). If the image capture time meets the requirements, then the image capture device 100 may wait until the occurrence of the image capture time (block 735) and once the image capture time arrives, the image capture may be initiated (block 720). If an image capture time is not available or if the image capture time does not have sufficient duration, then the image capture device 100 may notify the user (block 740). The image capture device 100 may notify the user of the excessive motion by blinking a light, displaying a “shake” indicator on a display of the image capture device 100, play a warning sound, or so on. After notifying the user, the image capture device 100 may return to block 705 to determine image capture exposure conditions and to retrieve new image capture device motion information to repeat the determination if an image may be captured. Optionally, the image capture device 100 may repeat the determination if an image may be captured until a terminating condition is met (block 745). Examples of a terminating condition include the user releasing the shutter button, an image being captured, a specified amount of time expiring, or so forth.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An electronic device comprising:
an image sensor to capture optical information;
a shutter coupled to the image sensor to initiate a capturing of optical information by the image sensor;
a motion sensor to measure movement of the electronic device; and
a processor coupled to the image sensor, to the shutter, and to the motion sensor, the processor configured to control a state of the shutter based on predicted future movements of the electronic device, wherein the predicted future movements are based on movement information provided by the motion sensor.

2. The electronic device of claim 1, wherein the processor initiates the capturing of optical information when the predicted future movements of the electronic device are less than a specified amount for a period of time required to capture the optical information.

3. The electronic device of claim 2, wherein the processor initiates the capturing of optical information when a maximum or a minimum of the predicted future movements exceeding a specified amount will occur at about a middle of the capturing.

4. The electronic device of claim 1, wherein the shutter initiates the capturing by opening an aperture, allowing the optical information to become incident to the optical sensor.

5. The electronic device of claim 4, wherein the image sensor comprises photographic film.

6. The electronic device of claim 4, wherein the image sensor comprises an optoelectric converter.

7. The electronic device of claim 1, wherein the shutter comprises an electronic shutter that initiates a reading of electrical values from the image sensor.

8. The electronic device of claim 1, wherein the motion sensor comprises a sensor selected from a group consisting of: gyroscopic devices, accelerometers, angular accelerometers, ultrasonic sensors, inductive position sensors, and combinations thereof.

9. The electronic device of claim 1, further comprising a memory coupled to the processor, the memory to store image data.

10. A method for capturing a still image, the method comprising:
determining exposure conditions;
retrieving motion information;
if the motion information exceeds a minimum motion, notifying a user that the motion exceeds the minimum motion; and
if the motion information does not exceed the minimum motion, capturing the still image.

11. The method of claim 10, wherein the notifying comprises alerting the user with an alert selected from a group of alerts consisting of: flashing a light, playing a sound, displaying a message on a display screen, vibrating a device used for the capturing, and combinations thereof.

12. The method of claim 10, wherein the motion information comprises detected motion of a device used for the capturing.

13. The method of claim 10, wherein the notifying further comprises repeating the retrieving and the determining.

14. The method of claim 13, wherein the retrieving and the determining is repeated until a terminating condition is met, and wherein the terminating condition is selected from a group of conditions consisting of: a user releasing a shutter button, the still image being captured, a specified amount of time expiring, and combinations thereof.

15. A method for capturing a still image, the method comprising:
determining exposure conditions;
retrieving motion information;
capturing the still image in response to a determining that the motion information does not exceed a minimum threshold motion; and
in response to the determination that the motion information exceeds the minimum threshold motion,
selecting an image capture time based on the motion information,
waiting until the image capture time, and
capturing the still image.

16. The method of claim 15, wherein the selecting comprises:
creating a predictive model of the motion of a device used to capture an image; and
selecting the image capture time, wherein the image capture time spans a period of time wherein any motion of the device is lower than the minimum motion for an acceptable still image.

17. The method of claim 16, wherein the selecting of the image capture time based on the motion information further comprises selecting the image capture time, wherein the image capture time spans a maximum motion or a minimum motion of the device.

18. The method of claim 16, wherein the predictive model predicts the occurrence of periodic movements.

19. The method of claim 15, further comprising after the selecting, notifying a user in response to a determining that no image capture time is available.

20. The method of claim 15, wherein a capturing of the still image comprises:
retrieving electronic information from an image sensor; and
storing the electronic information along with motion information in a memory.
